(19) United States
(12) Patent Application Publication
(10) Pub. No.: US 2016/0167454 A1
(43) Pub. Date: Jun. 16, 2016

(54) Run-Flat, Puncture-Proof Tire Structure

(71) Applicant: Mu Chang HE, Taichung City (TW)

(72) Inventor: Mu Chang HE, Taichung City (TW)

(21) Appl. No.: 14/575,251

(22) Filed: Dec. 18, 2014

(30) Foreign Application Priority Data
Dec. 11, 2014 (TW) 103143235

(51) Int. Cl. B60C 17/01; B60C 17/06; B60C 19/12

(52) U.S. Cl. CPC B60C 17/01; B60C 19/12; B60C 17/065

(57) ABSTRACT

An improvement in run-flat, puncture-proof tire structure, in which the foamed inner tire body is formed of foam structure, which can provide the required softness/hardness for the tire by adjusting the proportion of foam material ingredients, and since the foamed inner tire body can be placed in the tire body hollow portion of the outer tire body, therefore it avoids blowout when a sharp object enters into and punctures the outer tire body, and it reduces the risk factors during motion, and the rim section positioned on the wheel rim body holds the inflatable inner tire body, and the inflatable inner tire body is also pressed up against the foamed inner tire body to absorb the vibration formed on the wheel rim body during motion, and since the problems of repair requirement and sudden blowout are still present after a puncture, it provides safety and stability during motion.

The current application claims a foreign priority to the patent application of Taiwan No. 103143235 filed on Dec. 11, 2014.

### BACKGROUND OF THE INVENTION

1. Field of the Invention

The present invention relates to an improvement in run-flat, puncture-proof tire structure, particularly to an application on vehicle wheel body structure in the related technical field.

2. Description of the Related Art

The prior art tire structure is shown in FIGS. 7 and 8, which is formed of an outer tire body 30 and a wheel frame body 40, and said outer tire body 30 and wheel frame body 40 are combined. Moreover, said wheel frame body 40 comprises a gas nozzle 41, and said gas nozzle 41 enables pumping air into the outer tire body 30. Said structure is classified as a (pneumatic) tire structure that needs to be inflated. There is also another tire structure (airless) that does not need to be inflated (not shown in the figures), which has a solid inner tire body installed within the outer tire body 30. As a result, above said two tire structures still have the following problems:

1. Poor safety: When said pneumatic tire structure is mounted on a vehicle and it encounters a sharp object on the road or pavement that punctures the tire and causes rupture of the inner tire body, which is commonly called as blow-out, this leads to an unbalanced and risky situation while driving and hence leads to poor safety.

2. Poor stability during movement of the vehicle: The solid inner tire body mounted into the outer tire body has a relatively heavy integral form, and the solid inner tire body has low capacity of absorbing vibration while in motion, which leads to poor stability and inconvenience during movement of the vehicle.

### SUMMARY OF THE INVENTION

The present invention relates to the problems of poor safety and instability during movement of a conventional tire structure, and therefore provides improvement in run-flat and puncture-proof tire structure.

The main purpose of the present invention is to provide improvement in run-flat, puncture-proof tire structure, which comprises a wheel rim body and a tire group, in which said wheel rim body has a rim section, wherein this rim section has a tire bead seat portion both on the left side and the right side, separately; and also a tire group having an outer tire body, a foamed inner tire body, and an inflatable inner tire body, in which said foamed inner tire body is made of a foam structure, and the outer tire body is provided with a tire body hollow portion, and the tire body hollow portion has a tire bead portion as separately provided in both sides, and a tire lip portion is provided along the tire bead portion, and the top surface of the foamed inner tire body is encircled with an outer rim section, and said outer rim section surface is encircled with an outer adhesive surface, as well as the side surface of the foamed inner tire body is encircled with a lateral rim section, and said lateral rim section surface is encircled with a lateral adhesive surface, and the inflatable inner tire body has a gas nozzle, and said foamed inner tire body and the inflatable inner tire body can be placed in the tire body hollow portion of the outer tire body, and the outer adhesive surface positioned on the outer rim section and the lateral adhesive surface positioned on the lateral rim section of the foamed inner tire body are pressed up against and adhered to the tire body hollow portion inner wall of the outer tire body, and inner side surface of the inflatable inner tire body is held by the rim section positioned on the wheel rim body, and the tire bead portion of the outer tire body is fitted on the tire bead seat portion, and the foamed inner tire body of the tire group is made of a foam structure, which can provide the required softness/hardness for the tire by adjusting the proportion of ingredients of the foam material, and since the foamed inner tire body can be placed in the tire body hollow portion found on the outer tire body, therefore it is likely to avoid blowout (flat tire) situation when a sharp object enters into and punctures the outer tire body, and as a result it reduces the risk factors while the vehicle is in motion, and the rim section positioned on the wheel rim body holds the inflatable inner tire body, and the inflatable inner tire body is also pressed up against the foamed inner tire body in order to absorb the vibration formed on the wheel rim body during motion of the tire group, and since the problems of repair requirement and sudden blowout of the tire are still present after a puncture, it provides safety and stability of the structure during motion.

### BRIEF DESCRIPTION OF THE DRAWINGS

FIG. 1 shows the three dimensional view of the present invention.

FIG. 2 shows the exploded view of the present invention.

FIG. 3 shows the side section view of the present invention.

FIG. 4 shows the tire group inflatable inner tire body inflating part profile view of the present invention.

FIG. 5 shows the way of use of the tire group when a sharp object punctures the tire of the present invention.

FIG. 6 shows an embodiment of the present invention structure.

FIG. 7 shows the exploded view of the prior art tire structure.

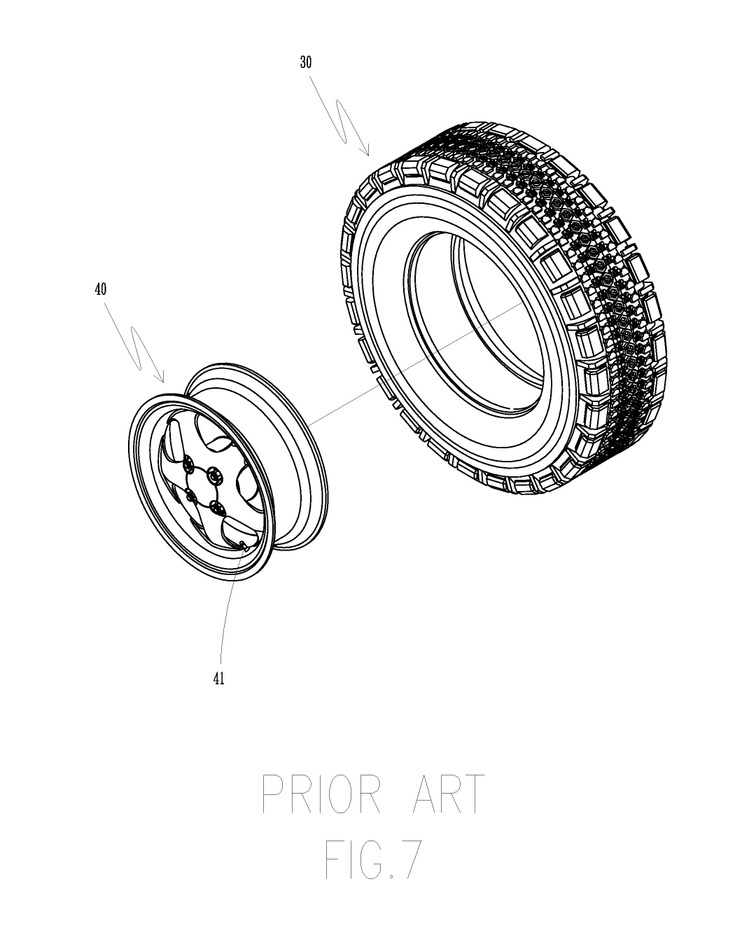

FIG. 8 shows the way of use of the prior art tire structure when a sharp object punctures the tire.

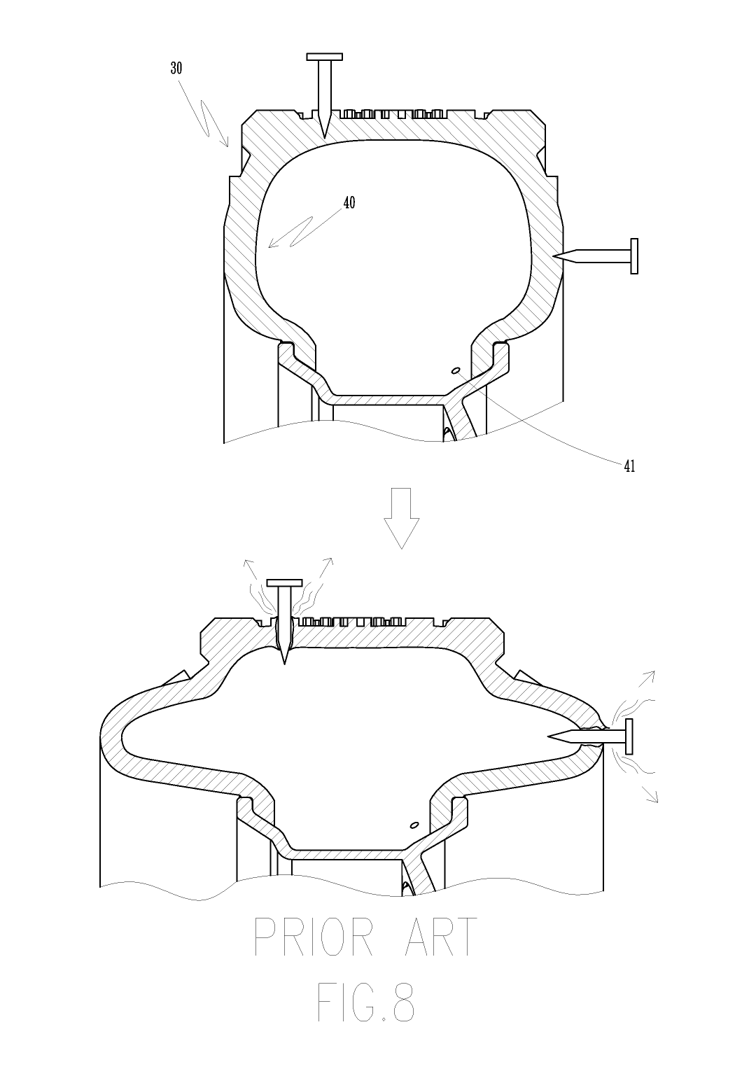

### DETAILED DESCRIPTION OF THE PREFERRED EMBODIMENTS

The aforementioned and other objectives, technical characteristics and advantages of the present invention will become apparent with the detailed description of preferred embodiments and the illustration of related drawings as follows, which are not limiting the invention and only given for illustration purposes, and the scope of the invention is only limited by the attached claims.

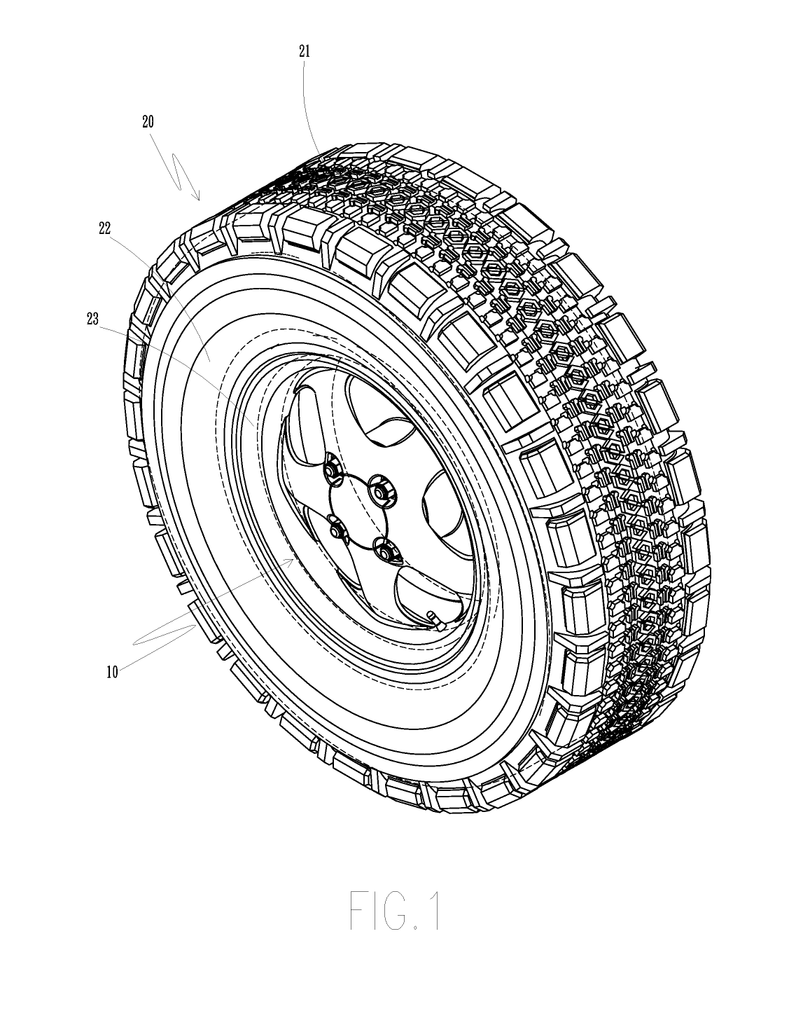

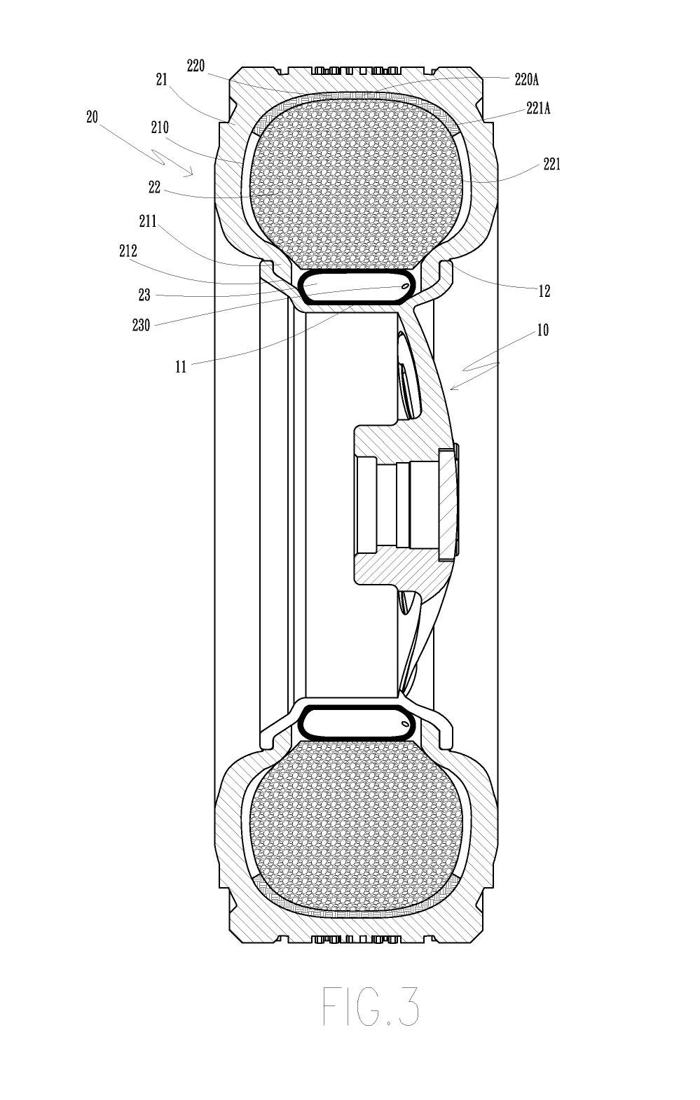

In FIGS. 1 to 3, the three dimensional structure, exploded view, and the side section view of the present invention run-flat, puncture-proof tire structure improvement is given, which comprises:

A wheel rim body 10, wherein said wheel rim body 10 comprises a rim section 11, which has a tire bead seat portion 12 both on the left side and the right side of the rim section 11, separately; and also

A tire group 20, wherein said tire group 20 comprises an outer tire body 21, a foamed inner tire body 22, and an inflatable inner tire body 23, and the foamed inner tire body 22 is made of a foam structure, and the outer tire body 21 is provided with a tire body hollow portion 210, wherein said tire body hollow portion 210 has a tire bead portion 211 as separately provided in both sides, and a tire lip portion 212 is provided along the tire bead portion 211, and the top surface of the foamed inner tire body 22 is encircled with an outer rim section 220, and said outer rim section 220 surface is encircled with an outer adhesive surface 220A, as well as the side surface of the foamed inner tire body 22 is encircled with a lateral rim section 221, and said lateral rim section 221 surface is encircled with a lateral adhesive surface 221A at the parts close to the edge, and the inflatable inner tire body 23 has a gas nozzle 230, and said foamed inner tire body 22 and the inflatable inner tire body 23 can be placed in the tire body hollow portion 210 of the outer tire body 21, and the outer adhesive surface 220A positioned on the outer rim section 220 of the foamed inner tire body 22 is pressed up against and adhered to the tire body hollow portion 210 inner wall of the outer tire body 21, as well as the lateral adhesive surface 221A positioned on the lateral rim section 221 is pressed up against and adhered to the lateral inner wall of the tire body hollow portion 210 of the outer tire body 21, and the outer side surface of said inflatable inner tire body 23 is pressed up against the inner side surface of the foamed inner tire body 22, in which the inner side surface of the inflatable inner tire body 23 is held by the rim section 11 positioned on the wheel rim body 10, and the tire bead portion 211 and tire lip portion 212 of the outer tire body 21 are fitted on the tire bead seat portion 12; and Improvement is achieved in the run-flat, puncture-proof tire structure of the present invention according to the tire structure described above.

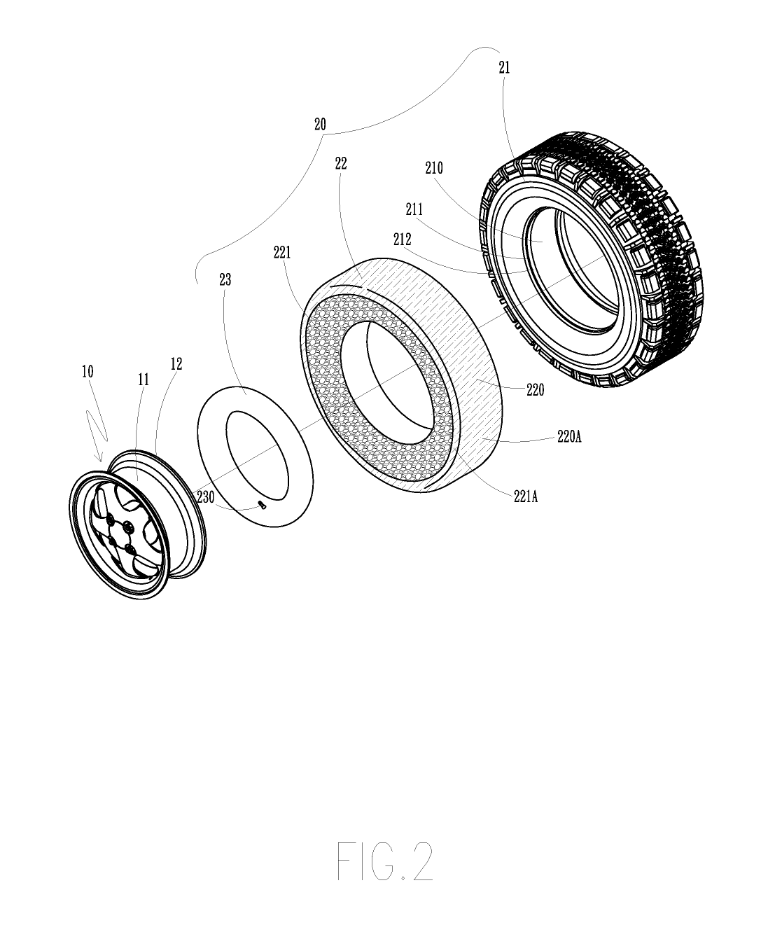

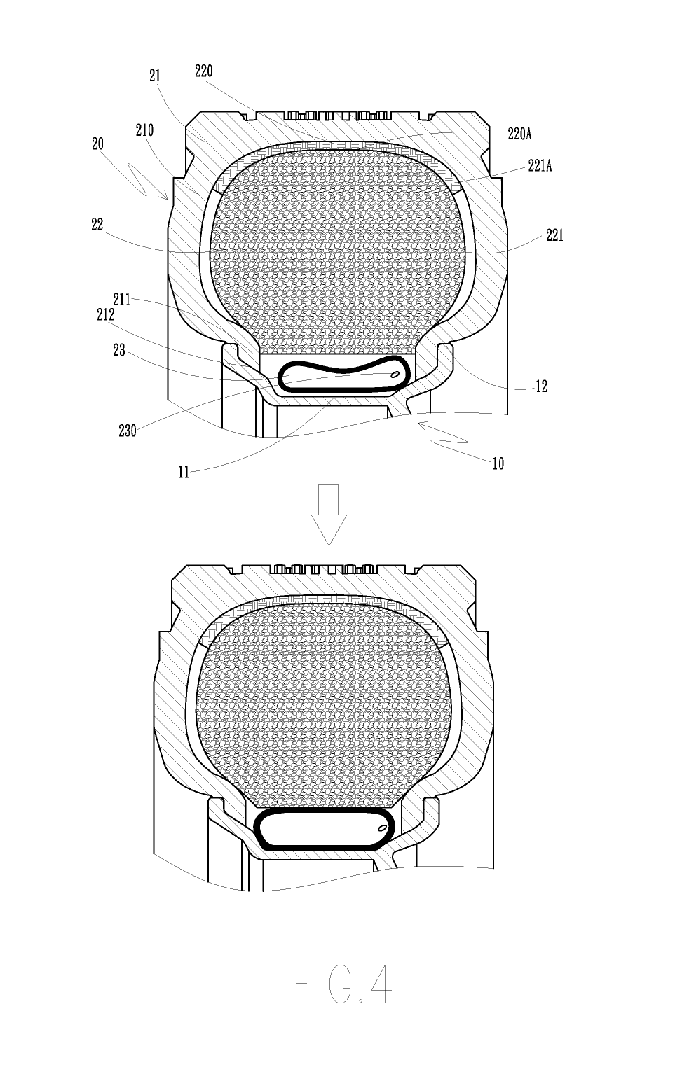

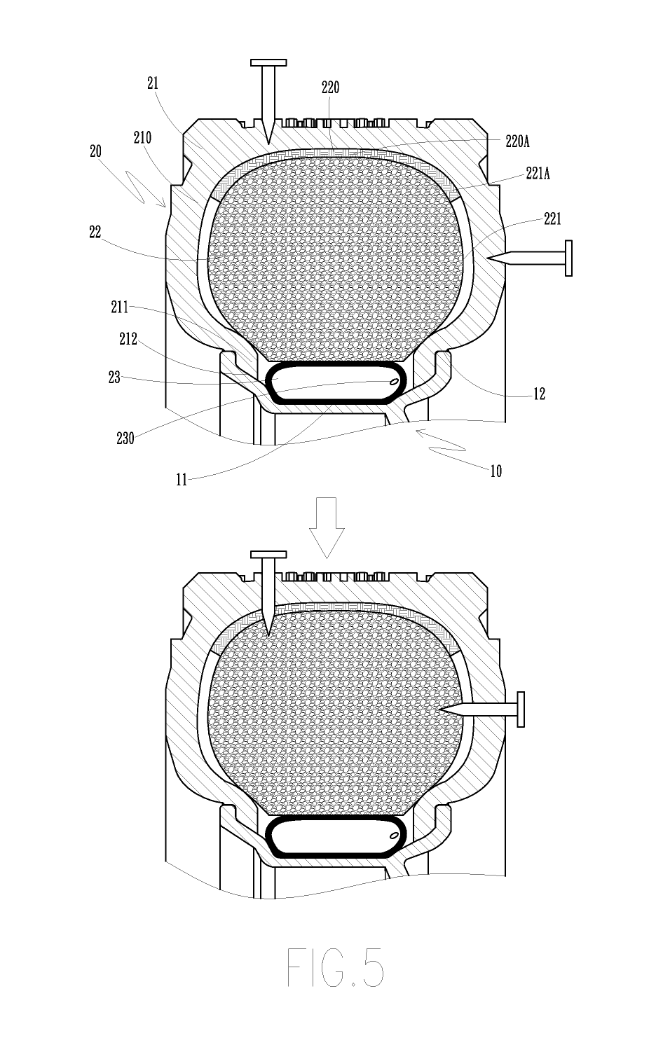

In FIGS. 2 to 5, the exploded assembly drawing of the present invention improvement in run-flat, puncture-proof tire structure, the side-view profile, the tire group inflatable inner tire body inflating part profile, and the way of use of the tire group when a sharp object punctures the tire are shown as reference, in which the outer adhesive surface 220A positioned on the outer rim section 220 of the foamed inner tire body 22 and the lateral adhesive surface 221A positioned on the lateral rim section 221 are pressed up against and adhered to tire body hollow portion 210 inner wall of the outer tire body 21, and the rim section 11 positioned on the wheel rim body 10 holds the inflatable inner tire body 23, and the tire bead seat portion 12 is fitted to the tire bead portion 211 and the tire lip portion 212 found on the outer tire body 21, and the foamed inner tire body 22 of the tire group 20 is made of a foam structure, which can provide the required softness/hardness for the tire by adjusting the proportion of ingredients of the foam material, and since the foamed inner tire body 22 can be placed in the tire body hollow portion 210 found on the outer tire body 21, therefore it is likely to avoid blowout (flat tire) situation when a sharp object enters into and punctures the outer tire body 21, and as a result it reduces the risk factors while the vehicle is in motion, and the rim section 11 positioned on the wheel rim body 10 holds the inflatable inner tire body 23, and the inflatable inner tire body 23 is also pressed up against the foamed inner tire body 22 in order to absorb the vibration formed on the wheel rim body 10 during motion of the tire group 20, and since the problems of repair requirement and sudden blowout of the tire are still present after a puncture, it provides safety and stability of the structure during motion.

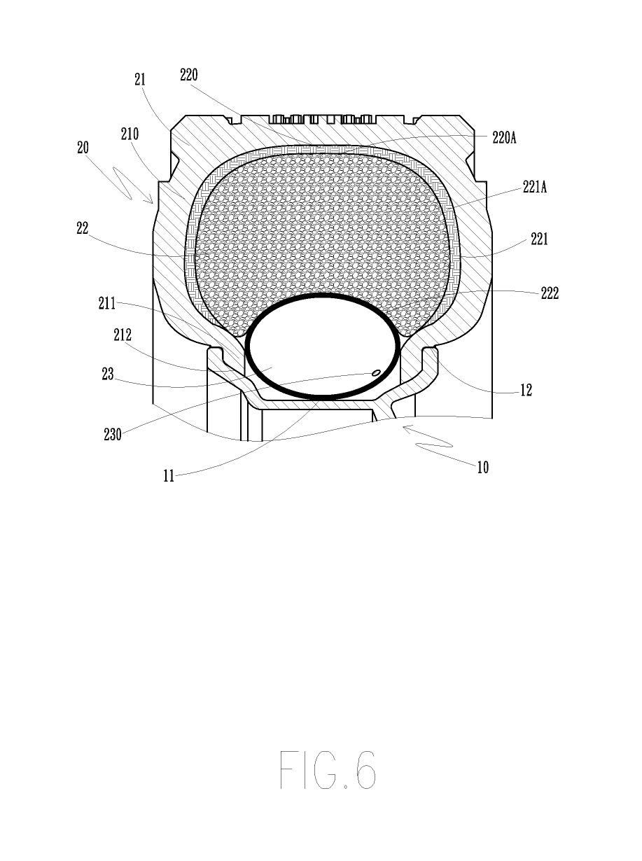

In FIG. 6, an embodiment of the present invention run-flat, puncture-proof tire structure improvement is shown as reference, in which the whole structure is identical to the ones shown in FIGS. 1 to 5, except a concave part 222 is found within the foamed inner tire body 22, and the outer adhesive surface 220A positioned on the outer rim section 220 is pressed up against and adhered to the tire body hollow portion 210 inner wall of the outer tire body 21, and the lateral adhesive surface 221A positioned on the lateral rim section 221 is pressed up against and adhered to the tire body hollow portion 210 lateral inner wall of the outer tire body 21, and the inflatable inner tire body 23 outer side surface is held by the concave part 222 found on the foamed inner tire body 22, and the inflatable inner tire body 23 inner side surface is held by the rim section 11 found on the wheel rim body 10, and said tire bead seat portion 12 is fitted to the tire bead portion 211 and the tire lip portion 212 positioned on the outer tire body 21, so that multifunctionality of the present invention is increased.

What is claimed is:

1. An improvement in run-flat, puncture-proof tire structure, which comprises:
A tire group, said tire group having an outer tire body, a foamed inner tire body, and an inflatable inner tire body, and the outer tire body having a tire body hollow portion, said tire body hollow portion having a tire bead portion positioned as separately on both sides, and a tire lip portion is positioned along the tire bead portion, and the foamed inner tire body top surface is encircled by an outer rim section, and said outer rim section surface is encircled by an outer adhesive surface, and the foamed inner tire body side surface is encircled by a lateral rim section, and said lateral rim section surface is encircled by a lateral adhesive surface, and a gas nozzle is positioned on the inflatable inner tire body, said foamed inner tire body and inflatable inner tire body can be placed into the tire body hollow portion of the outer tire body, and an outer adhesive surface is positioned on the outer rim section and a lateral adhesive surface is positioned on the lateral rim section of the foamed inner tire body, which are pressed up against and adhered to the tire body hollow portion of the outer tire body, and said inflatable inner tire body outer surface is pressed up against the inner side surface of the foamed inner tire body.

2. An improvement in run-flat, puncture-proof tire structure according to claim 1, wherein said foamed inner tire body is made of foam structure.

3. An improvement in run-flat, puncture-proof tire structure according to claim 1, wherein lateral adhesive surface is positioned on the lateral rim section of said foamed inner tire body, and it is pressed up against and adhered to the tire body hollow portion lateral inner wall of the outer tire body.

4. An improvement in run-flat, puncture-proof tire structure according to claim 1, wherein a concave part is found at the inner side of said foamed inner tire body, in which the outer side surface of the inflatable inner tire body is held by the concave part positioned at the inner side of the foamed inner tire body, and a lateral adhesive surface is positioned on the lateral rim section of the foamed inner tire body, and it is pressed up against and adhered to the tire body hollow portion lateral integral wall of the outer tire body.

5. An improvement in run-flat, puncture-proof tire structure, which comprises:
a wheel rim body, said wheel rim body having a rim section, and the rim section having a tire bead seat portion positioned separately on both sides; and also
a tire group, said tire group having an outer tire body, a foamed inner tire body, and an inflatable inner tire body, wherein the outer tire body has a tire body hollow portion, and said tire body hollow portion has a tire bead portion separately on two sides, and a tire lip portion extends along the tire bead portion, and the foamed inner tire body top surface has an outer rim section, and said outer rim section surface is encircled by an outer adhesive surface, and the foamed inner tire body side surface has a lateral rim section, and said lateral rim section surface is encircled by a lateral adhesive surface, and a gas nozzle is provided on the inflatable inner tire body, and said foamed inner tire body and inflatable inner tire body can be placed in the tire body hollow portion of the outer tire body, and an outer adhesive surface is provided on the outer rim section and a lateral adhesive surface is provided on the lateral rim section of the foamed inner tire body, and they are pressed up against and adhered to the tire body hollow portion inner wall of the outer tire body, and said inflatable inner tire body outer side surface is pressed up against the foamed inner tire body inner side surface, in which the inflatable inner tire body 23 inner side surface is held by the rim section found on the wheel rim body, and the tire bead portion and the tire lip portion of the outer tire body are fitted to the tire bead seat portion.

6. An improvement in run-flat, puncture-proof tire structure according to claim 3, wherein said foamed inner tire body is made of foam structure.

7. An improvement in run-flat, puncture-proof tire structure according to claim 3, wherein lateral adhesive surface is positioned on the lateral rim section of said foamed inner tire body, and it is pressed up against and adhered to the tire body hollow portion lateral inner wall of the outer tire body.

8. An improvement in run-flat, puncture-proof tire structure according to claim 3, wherein a concave part is found at the inner side of said foamed inner tire body, in which the outer side surface of the inflatable inner tire body is held by the concave part positioned at the inner side of the foamed inner tire body, and a lateral adhesive surface is positioned on the lateral rim section of the foamed inner tire body, and it is pressed up against and adhered to the tire body hollow portion lateral integral wall of the outer tire body.
